(19) United States
(12) Patent Application Publication
(10) Pub. No.: US 2006/0052113 A1
(43) Pub. Date: Mar. 9, 2006

(54) Roaming presence and context management

(76) Inventors: Shai Ophir, Moshav Ein-Vered (IL); Shlomo Wolfman, Hod-HaSharon (IL); Ory Biran, Kiryat-Tivon (IL); Alon Barnea, RaAnana (IL)

Correspondence Address: Martin D. Moynihan;PRTSI, Inc., P.O. Box 16446, Arlington, VA, 22215, US

(21) Appl. No.: 11/200,010

(22) Filed: Aug. 10, 2005

Related U.S. Application Data
(60) Provisional application No. 60/607,258, filed on Sep. 7, 2004.
(60) Provisional application No. 60/650,513, filed on Feb. 8, 2005.

(51) Int. Cl. H04Q 7/20

(52) U.S. Cl. 455/456.1; 455/436; 455/435.1

(57) ABSTRACT

Apparatus for mediating between a cellular telephony network and a wireless LAN, comprises a first adaptor for allowing signal exchange with the cellular telephony network, a second adaptor for allowing signal exchange with the wireless LAN; and a presence tracker associated with the adaptors for obtaining and storing a current location of a wireless device on any of the networks. The apparatus allows for mobile wireless devices to connect to wireless LANs and be able to register and receive services from their mobile operator, by treating the LAN in the same way as a foreign network in International roaming.

### RELATED APPLICATIONS

The present application claims priority from U.S. Provisional Patent Applications No. 60/607,258, filed on Sep. 7, 2004, and U.S. Provisional Patent Application No. 60/650,513, filed on Feb. 8, 2005, the contents of which are incorporated herein by reference.

### FIELD AND BACKGROUND OF THE INVENTION

The present invention relates to roaming presence and context management and, more particularly, but not exclusively to such presence and context management to allow convergence of cellular networks and other, non-cellular wireless networks such as Wireless LANs, including WiFi and WiMAX based networks, proprietary networks of different kinds and networks based on unlicensed wireless access (UMA).

The convergence of cellular networks and wireless LANs is necessary in order to utilize the ability of wireless LANs to be useful. At the moment if a cellular user needs to obtain a credit card number every time he passes by a given wireless LAN then use of the LANs will be minimal. Indeed use of the LANs will be restricted to those people who are spending time in the location of a particular LAN. Furthermore, the ability to allow full utilization of LANs is a part of the direction in which cellular telephony is intended to expand beyond 3G.

As a further point, there are wireless devices such as portable computers which are mainly suitable for the IP-based wireless LANs, whereas cellular telephones might be able to use either. Allowing for convergence would enable interoperability between cellular telephones and mobile computers for example.

There have been standards set for interoperability between cellular and wireless networks. Official Document IR.61. caters for a user who has an account at one wireless LAN operator, through which the user can be authenticated by the other networks. However the solutions provided therein are based on the assumption of common ownership between the cellular operators and the WLAN operators and therefore that location and account information from the cellular network can be made available directly to the wireless LAN, and vice versa, in the case of GSM from HLR, and the Radius server.

Reference is also made to the document INTEL, IDA Public WLAN Interworking Study, Jan. 12, 2004 draft version 0.8, see especially FIG. 4, which provides an intermediate server for clearing and settlement between LANs and GSM. However it only caters for payment and does not provide for interoperability between the networks, neither does it provide any kind of synergy in services made available.

There is thus a widely recognized need for, and it would be highly advantageous to have, a system allowing convergence of cellular and wireless LANs which is devoid of the above limitations.

### SUMMARY OF THE INVENTION

According to one aspect of the present invention there is provided a server for tracking presence of wireless devices over a plurality of networks comprising:
a presence & location database, and a plurality of adapters for obtaining wireless device presence or location data from respective ones of said plurality of networks to place in said database, thereby allowing wireless devices to be tracked over said plurality of networks.

According to a further aspect of the present invention there is provided a method of providing a wireless device with seamless access to a plurality of wireless non-cellular and cellular networks having respective registration systems, the method comprising:
setting one of said networks as a home network for said wireless device; and
providing Interworking functionality between said wireless non-cellular and cellular networks to allow a wireless device to connect as a roaming user on a non-cellular or cellular network other than said home network such that said connection is accepted via registration at said home network using a respective home network registration system, thereby allowing said wireless device to move freely between said plurality of non-cellular and cellular networks.

According to a further aspect of the present invention there is provided a server system for tracking presence and location of wireless devices, the system comprising:
a plurality of servers, each having
a presence database for tracking a plurality of wireless devices over a plurality of networks, and
a plurality of adapters for obtaining wireless device presence data from respective ones of said plurality of networks to place in said database, thereby allowing wireless devices to be tracked over said plurality of networks,
the system being configured such that information is shared between said servers, thereby to permit tracking presence of said wireless devices.

According to a further aspect of the present invention there is provided a method for determining that a subscriber is in a vehicle, comprising:
receiving location data of a given mobile communication device connected via a wireless network, if said location data is changing at above a predetermined rate then inferring that the corresponding subscriber is in a moving vehicle.

According to a further aspect of the present invention there is provided apparatus for allowing use of unlicensed mobile access to a roaming user connecting at a network other than his home network, the apparatus comprising:
a detector for detecting that said user is roaming at a given roaming location; and
a presence update unit, associated with said detector for sending to said home network and an indication of presence at said roaming location to identify his home network, thereby to allow registration of said roaming user at said home network when connected from said unlicensed mobile access.

According to a further aspect of the present invention there is provided apparatus for mediating between a cellular telephony network and a non-cellular wireless network, the apparatus comprising:
a first adaptor for allowing signal exchange with said cellular telephony network;
a second adaptor for allowing signal exchange with said non-cellular wireless network; and
a presence tracker associated with said adaptors for obtaining and storing a current location of a wireless device on any of said networks.

According to a further aspect of the present invention there is provided apparatus for making user profile information available over a plurality of user devices connecting via both IP and cellular networks, the apparatus comprising:
a cellular adaptor for connection to a cellular network;
an IP adaptor for connection to an IP network;
a user profile database for storing user profiles of a plurality of users; and
a tracking unit associated with said cellular adaptor, said IP adaptor and said user profile database, for identifying and tracking devices connected to said networks and making user profile data of a corresponding user available for a respective device.

According to a further aspect of the present invention there is provided apparatus for network selection comprising:
a database storing network parameters for a plurality of available networks; and
a user client, for applying to a wireless-communication-enabled device, for communicating with said database to determine from said network parameters a preferred one of said plurality of network for connection thereto.

According to a further aspect of the present invention there is provided apparatus for zoned use of a wireless communication device, comprising:
zone determination unit for defining a zone; and
location determination unit for determining a current location of a wireless communication unit, such that at least one predetermined condition is applied if said current location is within said zone.

According to a further aspect of the present invention there is provided a method for zoned use of a wireless communication device, comprising:
defining a zone; and
determining a current location of a wireless communication unit, such that at least one predetermined condition for communication is applied if said current location is within said zone.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram showing a presence server according to one preferred embodiment of the present invention;

FIG. 2 is a simplified diagram showing the presence server of FIG. 1 in greater detail;

FIG. 3 is a simplified diagram showing a method of operation of the presence server of FIG. 1;

FIG. 4 is a simplified diagram showing the presence server of FIGS. 1 and 2 in greater detail,

FIG. 5 is a simplified diagram illustrating how a system according to the present invention bridges between the cellular and WLAN worlds; and

FIG. 6 illustrates a service provided to mobile users that is modified according to the context, according to a preferred embodiment of the present invention.

### DESCRIPTION OF THE PREFERRED EMBODIMENTS

The present embodiments comprise a centralized mechanism for tracking wireless devices as they move between networks. The mechanism provides a transparent functional link between the networks for registration and billing of the devices and interoperability of the networks in general, and allows forwarding of incoming calls and to whichever of the networks a given wireless device happens to be connected at the time. The present embodiments also allow the possibility of making network services from one network available to users at another network, not an easy task when bearing in mind that cellular based services may have to be adapted to the IP world.

The principles and operation of a centralized mechanism according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

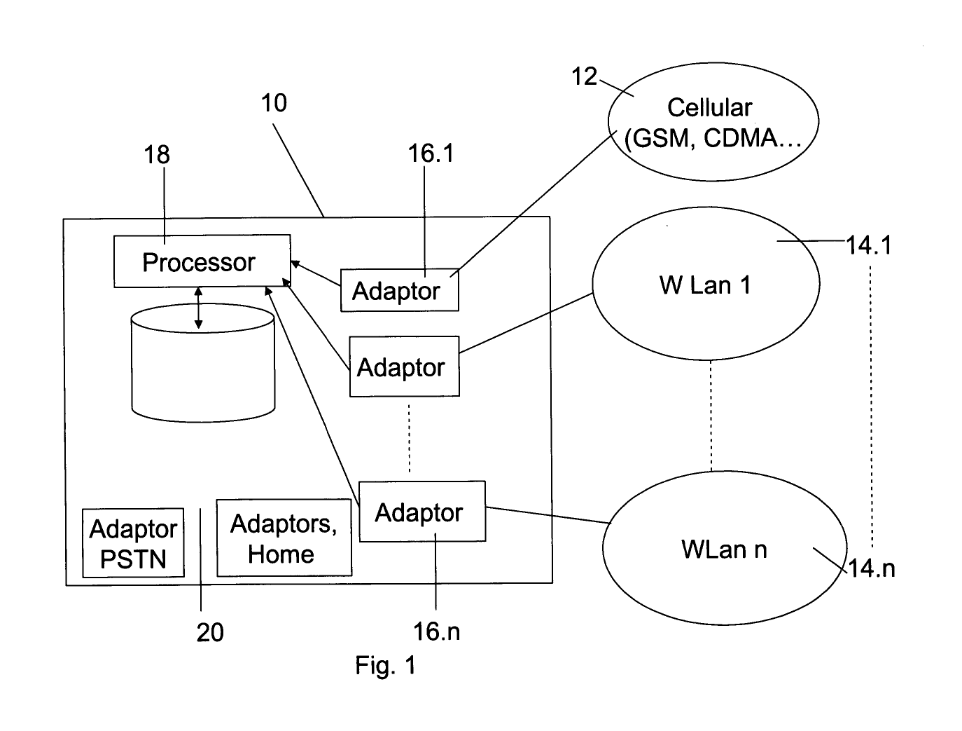

Reference is now made to FIG. 1, which illustrates a server 10 that is connected to a plurality of different kinds of network, thus cellular network 12, and Wireless LAN networks 14.1 . . . 14.n. The server provides a centralized mechanism for conferring interoperability between the different kinds of networks, as will be explained below. The connection is preferably via control connections such as SS7 signaling connections. Each network is connected via a specific adaptor 16.1 . . . 16.n that is able to pick up event triggers of different kinds from that particular network. The adaptors are tailored as necessary for the signaling protocols on the specific network so that all relevant events on all of the networks can be detected in the wide variety of protocols that the various networks may use. The adaptors then adapt the signals to a uniform format for the server 10.

Data from the adaptors is passed to a processing module 18 and placed in a presence database 20. The presence database operates as an extension of the home location register HLR on a cellular network in that it keeps records of wireless devices and their current locations, not just in the individual network, but in a host of connected networks. Thus a caller wishing to establish a connection with a given wireless device may consult the presence database 20 and find out the current location of the desired wireless device. The call is then routed according to the information obtained from the presence database.

Similarly the presence database allows users that it recognizes to register on any one of the networks it serves. Thus all users registered on the HLR of cellular network 12 can register via any of wireless LANs 14.1 . . . 14.n by virtue of being treated as roaming users at the wireless LAN. The conventional use of the term roaming is to describe a cellular user who connects when outside the geographical reach of his home network, to a network other than his home network. This usually occurs when traveling abroad. In the present context the term roaming is also used to describe connecting to any network other than the user's home network, such as a wireless LAN. In conventional roaming, the host or roaming network determines the home network of the user and asks the home network to register the user. If the home network issues a signal indicating successful registration then the user is allowed to use the roaming network. In the present case the presence database allows the same to be achieved between the home network and wireless LANs.

Types of wireless LANs that may be involved include WiFi (IEEE 802.11), and WiMAX (IEEE 802.16).

It is noted that cellular networks include various kinds of cellular networks including GSM, and CDMA, each of which requires a different kind of adaptor.

In addition there may be provided an adaptor for a fixed-line network. An adaptor for a home network, such as a Bluetooth™ network or other kind of home network may be included.

One of the tasks that can be assigned to processing module 18 is to detect registration attempts of particular wireless devices at given networks and apply rules or policies to the registration. For example in certain areas more than one network might be available and the user may be actively directed to one or the other. Some networks may be intrinsically preferred, or certain users may be directed to certain networks, or some kind of attempt to balance between networks may be applied. Certain types of users, such as prepaid users, may be treated differently from other users. Generally prepaid users are not allowed to register to networks other than their home networks due to non-availability of relevant account information. However the server 10 according to the present embodiments may be configured to hold and manipulate account information, thus making activities involving prepaid users possible.

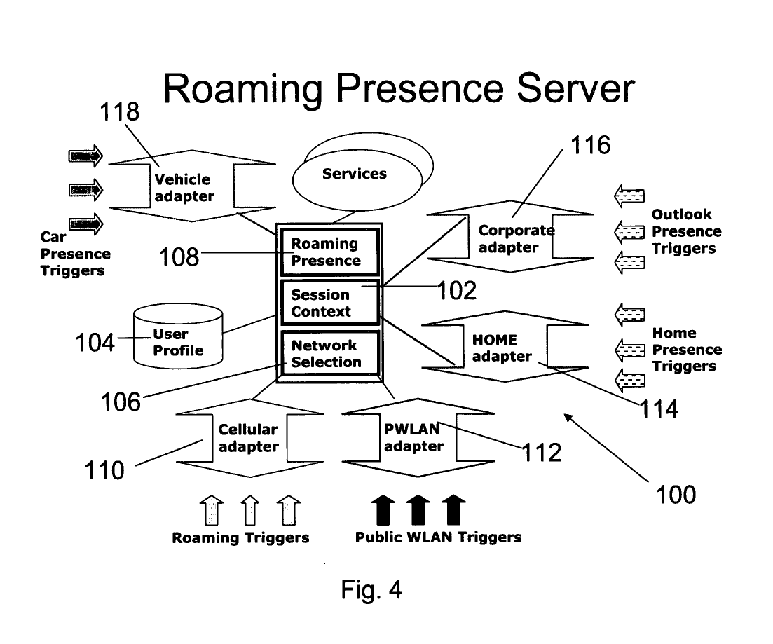

In a preferred embodiment, a user client, installed on the laptop or other device, decides which is the preferred one of any available network. The client comprises selection logic to select a network based on data stored in the client database. The data is preferably updated by the server during the course of a connetion. In order to carry out such an update, a database is provided on the server (106 in FIG. 4). It will be apparent to the skilled person however that somewhat different network selection mechanisms are required for GSM and for WiFi.

Typically, one of the networks is a cellular network, such as cellular network 12 illustrated, which is typically based on GSM or CDMA. The other networks are wireless LANs, which are typically based on the Internet protocol (IP). Thus the server typically has adaptors for IP, and GSM or CDMA which work over SS7 signaling connections. As already mentioned, other networks, such as fixed-line telephony networks, are also provided for, by use of suitable adaptors.

An illustration of the advantage of having unified functionality between the networks is the case of text messaging. Text messaging on a cellular network is generally based on the SMS format which is sent via the signaling connections within the cellular network. Text messaging on the IP networks is based on peer to peer connections using a messenger program. Unification of the networks by the server 10 allows SMS information to be extracted from the signaling links of the cellular networks and sent as text messages on the IP network.

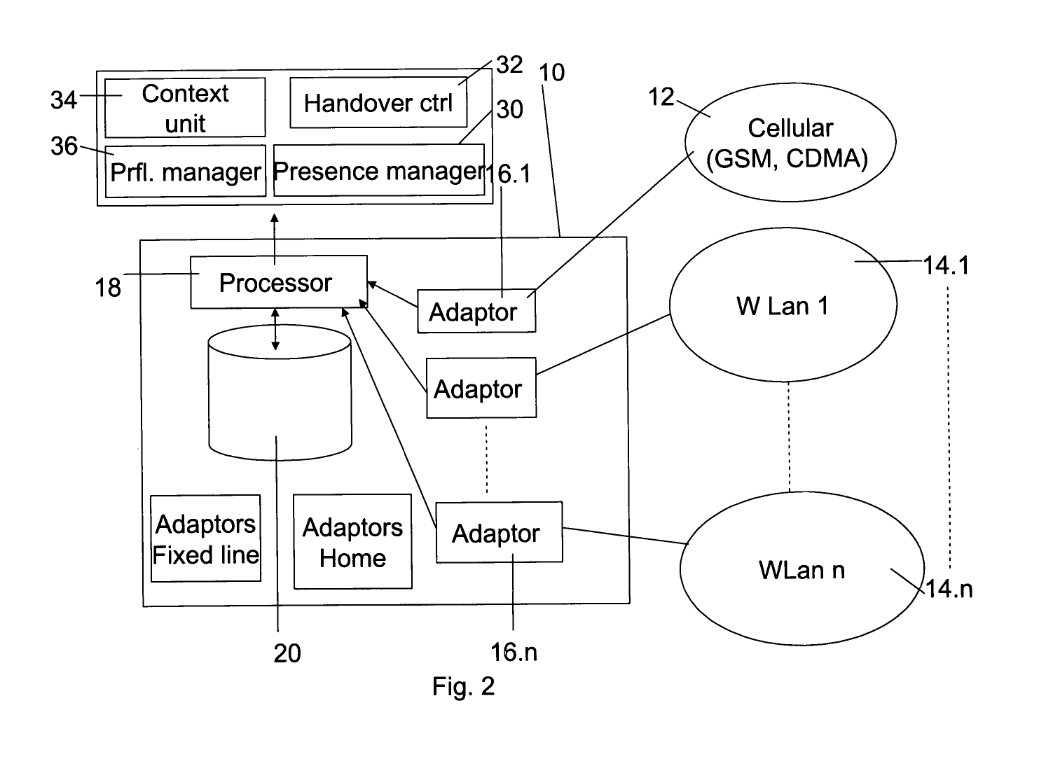

Reference is now made to FIG. 2, which shows an enlarged detail of the processing module 18 of FIG. 1. The processing module 18 comprises functional units as follows: a presence manager 30, a handover control unit 32, a context unit 34 and a user profile manager 36. The functions and significance of these units is now described.

The presence database manager 30 manages presence database 20, by obtaining signaling information from the various adaptors to identify specific wireless devices in the database, and then updating the database to indicate where the wireless device is found. It also responds to requests from incoming connections wishing to connect to the wireless device by forwarding the call to the currently known location.

The handover control unit 32 controls the passing of the wireless device between different networks, usually between the cellular network and one of the wireless LANs. Handover control unit 32 is further able to hand over a session (such as a voice call) between different devices, for example to hand over a call from the mobile device to a laptop]. The handover unit 32 may carry out automatic handovers much in the same way as cellular telephones are handed over between base stations in the cellular network. Alternatively it can intervene in the registration process to prevent registration to certain networks or to favor certain networks or the like. For example some wireless LANs might be particularly favored, or at particular times the local cellular network might be overloaded and so might wish to switch certain customers to available LANs in order to smooth out the load.

Context unit 34 obtains context information about a given connection, such as parameters of the individual connections over the different networks, for example parameters to indicate how the connection is being used, say whether data or voice is being transferred. More particularly, the context unit 34, or roaming context management (RCM) is a useful part of any infrastructure for Cellular and WLAN interoperability, session handover and service synergism. Interoperability implies roaming between networks, terminals and bearers. The context holds the current session parameters, as well as the aggregated user profile(s) attributes, ensuring the transparency of service continuity between different networks when handed over by handover unit 32, by minimizing the need, say, for re-authentication. The context shares user attributes of both Cellular network and WLAN, and is able to allow interoperability of value added services such as voicemail between these two environments. The context unit may be embodied as context management middleware, with the ability of controlling all session-related parameters with tightly coupled interfaces to the Cellular and WLAN networks.

The context unit may receive roaming triggers from both cellular and WLAN networks, acting as a unique point of network convergence, and thus it is located with the server 10 as illustrated. Alternatively, different context units can be hosted at different provider networks (Cellular and WLAN), each receiving its own triggers, and the current context is then delivered from one context unit to the other as session handover occurs. For example, if a phone call has started as a WLAN session (VoIP call from a laptop), a context is created at the context unit located at the WLAN provider network. When the user leaves the hotspot and would like the call to continue via the mobile, the context will be delivered to the context unit that is located at the MNO (Mobile Network Operator). The context thus serves as a personal roaming agent.

When the user has an account at one network, the context allows the user not only to be registered via a second network, but to enjoy the full benefit of his native network on this second network as well as any benefits of the second network. That is to say the context unit enables services on both cellular and WLAN networks simultaneously, providing service synergism and session handover between the two networks.

In one embodiment, the context may be used to control the handover unit to govern switching between networks. As a very simple example, it may be noted by the context unit that the wireless device is in the process of a data heavy download, for example of video data. Such a device may be best linked to any available wireless LAN. Another device involved in a voice call may be better served by remaining on the cellular network.

In an embodiment, the context unit may govern the provision of services to the devices. Thus a particular service may be provided in different ways depending on the context. For example it is possible to reroute SMS to a laptop client connected via IP-based WiFi, instead of the cellular device.

In addition, it is possible to carry out routing of voice calls to the laptop, using Voice over IP, (SIP), based on the presence indicated in the presence database. That is if the subscriber is connected to a WiFi network, and a call is made to the cellular device of the subscriber, the user's context as being on an IP network can be understood and the call can be routed to the laptop client instead.

One preferred embodiment of the present invention uses the handover and or context abilities in order to transfer a given connection between different devices. Thus a user who receives a call on a portable computer using a wireless LAN while on a train may arrive at his destination and wish to transfer the call to his mobile telephone so that he can keep talking as he moves. The wireless LAN may already have obtained data as to the user's destination so that when he arrives at the destination the handover unit can be triggered to transfer the call from the portable computer on the LAN to the mobile telephone via the cellular network.

In a further preferred embodiment one of the networks may be the wired LAN, say of an office, and the handover unit is able to transfer a call from a mobile telephone to a user's fixed office telephone when he is in proximity thereto.

In a further preferred embodiment an adaptor is provided for connection of the system to the regular telephone network, in which case the call can be transferred to any regular telephone.

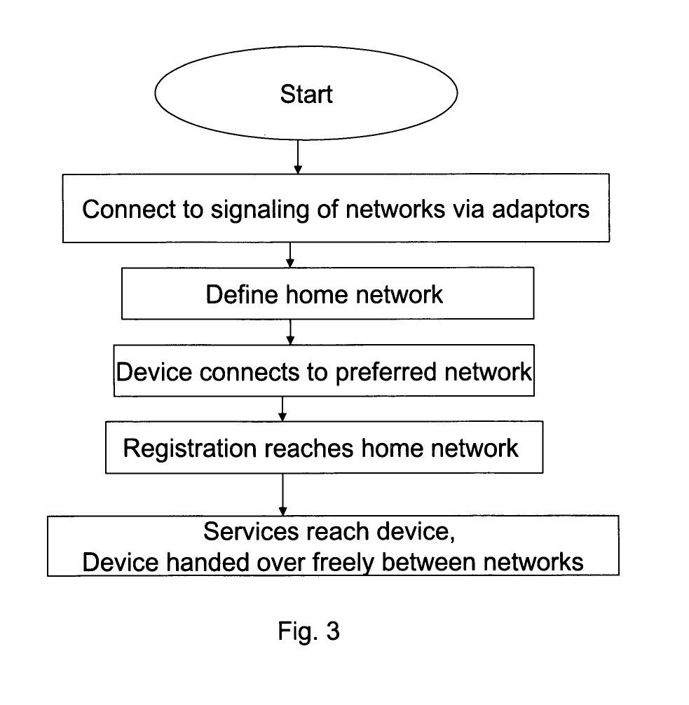

Reference is now made to FIG. 3, which is a flow chart illustrating a method of providing a wireless device with seamless access to various local area networks and to cellular networks each having their own independent registration systems. The method comprises:
setting one of the networks as a home network for said wireless device. This happens automatically for cellular telephones but not necessarily for other wireless devices; and
providing inter-working functionality, such as server 10 described above, to link to each of the networks via a system of adaptors so that it can understand the otherwise incompatible signaling information from the different networks.

Then, using the inter-working functionality, the wireless device is able to register as a roaming user on one of the other (that is not his home) networks using that network's respective registration system. The registration attempt is not actually made at the roaming network but is referred to his home network so that he can be authenticated. As a result there is created the effect of universal registration and the wireless device is able to move freely between the different networks. More particularly, in the case of the GSM or other cellular, network, the user registers directly. In case of a WiFi or other roaming network, the user is not actually registered to the roaming network, as it is in the cellular case. In the WiFi case, the registration attempt is in fact forwarded to the home cellular network, and registration is taken care of at the cellular network.

It is also noted that the user may connect different devices via the different networks. A cellular device may connect via the cellular network, and a laptop may be connected via WiFi. The presence server allows for a service synergism between these two networks That is to say, the presence server is able to deal with the same subscriber and identify multiple devices connected to different networks and allow them to work together.

It will be appreciated that a single server may be limited in the number of LAN networks it is able to include, and therefore in a further preferred embodiment of the present invention there is provided a system of such servers, each one containing network preference information regarding a certain subset of the available networks. The servers within the system are able to communicate with each other to provide preference information to any devices that need it and thus create seamless interoperability between all of the networks of all of the servers within the system. More particularly, the database of the preferred networks, that contains information regarding the roaming agreements and relationships between networks, may not necessarily be included in one single server. There may thus be provided a network of servers, in order to reach the home network via intermediate networks. The result is to give the effect of =DNS resolution over the internet, where a domain name is resolved by several routers along the way to the destination.

Server 10 may be understood as a multidimensional presence server, in the sense that each network involved is a separate dimension when determining presence, but note the more detailed definition of “multidimensional” below. The server provides interoperability by supporting roaming between the networks, interoperability being a key element in so-called “beyond 3G” wireless implementations.

The concept of Roaming has in the past been understood as roaming between different networks of the same kind, such as roaming between GSM networks in different countries. However in the present context is meant also roaming between different types of networks (such as GSM and WiFi), roaming between terminals and also roaming between personal states (work/home/leisure/etc), hence “multi-dimensional” roaming.

Interoperability, besides the basic application of having a session connected between different networks, or an SMS message sent from one network to the other, implies for example a session handover of a service between networks—handover of a telephony call from a mobile handset to a laptop for example, as well as service synergism—services provided by a combination of different terminals, networks and media capabilities in one session.

Server 10, or Multi-dimension Roaming Presence Server (MRPS) thus holds a current location of a particular wireless device or end user for each one of the networks to which it is connected. For example, if a user is roaming in a visited GSM network, and is also visiting a WiFi hotspot, the server 10 will hold the GSM location (a VLR address, and possibly location area or Cell ID), and also the WiFi hotspot location information. The server 10 receives roaming triggers from all networks involved, thus the cellular and WLAN networks of the previous example, and acts as a unique point of location information convergence. The server thus uses multiple sources of information in order to derive more accurate roaming location information.

It is noted in passing that there currently exists a device known as a Mobile Presence Server, which is intended to support instant messaging applications, involving instant communication directly between mobile subscribers. However the known mobile presence server has no relevance to tracing presence over different kinds of networks.

In the following are given a number of examples of different scenarios for detection of a user's presence, and possibly context as well.

In a first example we receive a GSM roaming location, in the form of a visitor location register (VLR) address, or possibly Location Area or Cell ID, along with a WiFi hotspot general location, giving at least a country & city name. The system may derive the exact hotspot location and the name of the service provider using the accumulated information from the two sources. Thus only one hotspot may accord with the particular VLR. In a second example we receive GSM location in the form of a cell ID, along with an indication from a client PC which reports a current connection of the end user to a LAN using a PC. This combination may indicate that the end user is at work or at home, say near a given hotspot. The client itself may provide explicit information to the system about the end user and his location.

Cellular operators would like these days to enter the fixed-line telecom market. They would like to provide what is known as FMC (Fixed-Mobile-Convergence).

One way for them to do so is to provide cheaper tariffs for what may be termed the “home zone”. That is, a cellular user may use her mobile handset while at home at a lower tariff, a tariff which is a competitive with that of the fixed-line telephone operator. The same can be applied to a predefined “work zone”, where the service can be offered to a corporate entity for example. The service can include other benefits than reduced tariff, and can provide information to the roaming presence server, described herein.

From the technical point of view, the main question is how to identify that the mobile subscriber is at home or at work (or at other recognized locations). The location should be relatively accurate, and provided at the resolution of a Mobile Network Cell or a Location Area at the most, that is a resolution of just a few cells. A location Area can still be used for the purpose of the home zone, since it covers the home and its close neighborhood. For the work zone, a Cell may in fact be too small, and a few Cells may actually be required to cover a large work place. In this context is is pointed out that in practice, through cordless phones, fixed-line operators in effect provide wireless support for their handset, up to a certain range from the handset base unit.

One known method to determine location is to use a mobile network location server. Such a method is expensive, since it requires the tracking of all subscribers, all the time, and today not many cellular networks actually maintain a location server. Another solution is based on monitoring the A-links of the mobile networks. A-links are the links between the Base Transceiver Station (BTS) or the Base Station Controller (BSC) and the Mobile Switch Center (MSC). This method is also very expensive, since it requires monitoring several links, and also tracks all subscribers all the time. Another method is to use Bluetooth™ technology at home. The Bluetooth™server, located at the home premises, senses the cellular handset while entering the home zone, and notifies the network. The solution however requires Bluetooth™ support at the handset, and requires installation of a Bluetooth™ server at home. Again, this solution is quite expensive and the components are not widely available just yet.

An alternative solution, making use of the present embodiments is now described. Such a solution is easier to implement, can be applicable to several handsets already deployed in the market, and is more efficient.

The solution is based on a client application installed at the mobile handset. Possibilities for such a client application include a GSM SIM card applet, for example based on Java, or a client a proprietary SIM vendor applet. The applet may be installed in a handset supporting STK SIM Toolkit, which includes the vast majority of handsets today.

Alternatively, the client may be a Symbian application for example, applicable for both GSM and CDMA cellular networks. Clients may be provided for other mobile device operating systems such as J2ME, BREW, Windows CE, LINUX, and for that matter any other mobile device operating system that supports the required triggers and event mechanism.

For the example of the SIM applet, we describe the case of a Java SIM card, as described by the 3GPP TS 03.19 version 8.5.0, GSM API for SIM toolkit stage 2. According to the above document, a SIM applet installed on the SIM card can request and receive a notification for any location change, using the following trigger: EVENT_EVENT_DOWNLOAD_LOCATION_STATUS. Other triggers, such as file change notification for the LOCI file may also be used. The location is saved on the SIM card LOCI file, and includes the current Location Area and/or the Cell ID, as described in the GSM 11.11, describing the SIM card files, GSM 04.08 where the LAI (Location Area Information) and LAC (part of the LAI) are described.

According to 3GPP TS 11.14 version 8.7.0, SIM-ME Interface, the proactive SIM command (SIM toolkit commands invoked by the SIM applet proactively) PROVIDE LOCAL INFORMATION can fetch the current location information from the mobile handset, including the Cell ID of the current serving cell. Therefore, in case the Cell ID is required, and is not provided by the LOCI file, the applet can use such a proactive command periodically, say every x seconds, and only while the handset is located at the home location area, in order to identify such an event as being served by a specific cell. The applet does not have to query the handset for the cell ID at all times, but only at the relevant location area. The trigger for entering the relevant location area may be provided as described hereinabove, and is always supported by the LOCI file.

The Java applet therefore receives a trigger for any change of the location area. Such a change in the location area may be either of the Location Area or the Cell ID. The applet then compares the new location area with the home location area whose identity is already stored in the applet for that specific subscriber. If the new location area is the home location area, the SIM applet notifies the network, using an application server located at the cellular network, that the mobile handset is in the home zone. The notification can be made using SMS or USSD or like technologies, as both are supported by the STK. If the new location area is not the home one, but the last registered location area was the home, that means the handset is now leaving the home zone. In such a case, a notification to the server may be sent as well.

It will be appreciated that the process is analogous for the work zone and any other zone that might be defined.

Each subscriber may thus have her own home zone location area, as well as work/office area and other preferred locations, stored in her personalized SIM card applet. The applet can store personal data in private files for example, or by other means provided for SIM applet data storage. If the subscriber moves to a new home address, or a new work, she can update the cellular network via the call center, and the new location area will be downloaded to the SIM applet via the OTA (Over the Air) mechanism.

Another update method could be via subscriber self-provisioning. While at home, the user invokes a SIM application, which records the current location area as the “home location area”. The same applies for the “work location area”. The user can then teach the SIM applet the home and work locations without bothering the cellular operator.

The above-described embodiment is applicable to any device that has an embedded SIM card, for example a mobile-enabled laptop.

In a further variation we receive a GSM location showing that the user is switching GSM cells at a relatively high speed. This information can be interpreted by the context unit to say that the user is in a vehicle. It would not necessarily indicate that the user is driving however. More accurate information can be gathered from an indication received from the mobile handset, which may be able to indicate that it is hooked to a car handset holder. This may be indicated by a client on the phone as a change into a ‘car profile’ and sending an SMS to a server.

The system may receive a trigger from the home WiFi provider that the user is currently connected to his home hotspot. This information can be combined with the GSM location information as well, and thereby ascertain that the detected connection to the home hotspot is the end user and not another family member for example.

The system may receive a trigger from a PC, after communicating with the mobile handset of the user (via Bluetooth for example), or vice versa, showing that the user is attached to the specific PC now.

The system may receive a trigger from any other equipment installed at the home/work premises, such as a Bluetooth network, reporting the location of the user.

As indicated, the above are mere examples for methods which can be used to collect roaming location and context. The different methods may be used together or separately, and some may be dispensed with whilst others are used at all times. In various cases, a single means may be sufficient for deriving the location needed for a specific service.

Reference is now made to FIG. 4, which is a simplified diagram illustrating a further embodiment of the roaming presence server 10.

Server 10 comprises roaming presence functionality 100 which follows the presence of the wireless device over the various networks which the server supports. The context unit 102, which is identical with context unit 34 described above, is an optional unit which uses different kinds of information in order to determine context information. Certain types of context information may be gathered from the location of the wireless device, such as which base station it is connected to or which wireless LAN or hotspot of the wireless LAN it is connected to. Other types of context information may be obtained from the type of connection, say data connection or voice connection. Yet other types of context may be taken from the status of the wireless device, say as reported by a client program located on the device. The information derived from the wireless device and networks may be combined with user profile information from user profile database 104. The user profile database may store any kind of information relevant to establishing a context. The user profile information may include information that the user himself enters, that the network management enters about the user or that the system learns about the user. The information may include the type of device, the type of uses to which it is put, a profile of the owner of the device, or even types of uses to which the device is put at different times of the day.

The network selection unit 106 is an optional part of the handover control 32 described above and manages deliberate selection between networks when more than one network is available to the device. As explained above, in one embodiment it provides the home network with the ability to intervene in the choice of network that the device connects to. In a further preferred embodiment it may be made available to to the user of the wireless device to allow him to exert control over the selection of the network. As mentioned above, network selection works slightly differently in WiFi and GSM.

Roaming presence unit 108 is the combination of tracking manager 30 and presence database 20 referred to above, and which receives trigger and other network information from the different adaptors to store in the database so that it has a constantly updated database indicating which network the wireless device is currently connected to. In addition, whenever the wireless device is not connected to its home network the roaming presence unit communicates a registration request to the home network and then communicates successful registration to the visited network so that the visited network knows to allow the connection. The roaming presence unit further acts as a unique point of convergence between cellular and WiFi presence and location.

The server 10 is shown here with six different adapters. A cellular adapter 110 receives signals such as trigger signals from GSM or CDMA or other kinds of cellular networks, and translates them into a common format. Public wireless LAN adapters 112 connect to specific wireless LANs to accept WiFi signals, via device clients, Radius/Diameter AAA server interfaces, and by other means, and translate these into the common format. Optionally there may be included home adapters 114 for connecting a user's home wireless LAN to the system, and corporate adapters 116 for connection of corporate networks to the system. As discussed above, a SIM applet may be used to recognize a home location.

On the user's private network, the system may allow the user to connect via his mobile telephone as is. For a laptop, especially other than his own, it may use a client such as a dialer-type program to which the user supplies a password. From the password the system may determine the user's mobile telephone number and make services etc available. Owners of home wireless networks could use the system to charge for use of their network. It is noted that the password is just one method. The authentication can be carried out in a number of ways. For example, the laptop can have an embedded SIM.

A vehicle adapter 118 accepts trigger signals from a LAN that is part of a vehicle, say that installed in a train, ship or aeroplane. Also a special adapter may identify a user in a vehicle and provide services which are adapted to the state of driving. Such an adaptor may identify or receive data identifying the status of being in the car by analyzing the speed of the serving cell update. The data for the identification, or for that matter the identification itself, may be provided by the device or by a server tracking the device, and other methods are known in the art.

In the following there is a discussion about specific signals involved in bridging between the GSM and WiFi standards.

The location of the wireless device when roaming can be received as follows:

Mobile roaming location can be received by monitoring the GSM MAP Update Location transactions, in the case of Roaming in a GSM network. Monitoring of the MAP update location transactions is possible through an SS7 signalling probe such as that described in co-pending European Patent Application No. 04101190.9, the contents of which are hereby incorporated by reference.

Mobile roaming location at the cell ID resolution level, can be obtained at the home network via CAMEL phase 3 transactions, as long as the home and visited networks support CAMEL phase 3, which may or may not be the case.

Mobile roaming location can also be gathered from a SIM applet as mentioned hereinabove, which can be loaded on the wireless device and can be triggered by every change of the LOCI SIM file. As a result it is able to report a new location to the server via SMS or via USSD communication.

Mobile location can also be received in general using a location server, or via SS7 probes installed at the network. The SS7 probes may monitor the A-links between the base station controller and the MSC for example. Mobile location can be obtained by other methods that may be provided by specific mobile operators.

WiFi hotspot location data can be sent from a PC client program which can be installed on a laptop. Such a user client may be installed on the laptop for the purpose of WiFi access, and may additionally support the preferred network selection procedure of the network selection unit 106. It is noted that network selection in itself is described in the Standards document 3GPP 23.234.

The WiFi location can be submitted to the system as a result of user input via the client. Thus the user may specify details such as country, city and like information, as is currently done with a PC dialer software client. The hotspot location can be further explored using the WiFi network SSID, or any other information available from the AAA server that the user was authenticated with.

The purpose of the WiFi network selection service is to direct the user to the WiFi providers preferred by the HPMN, in order to enable centralized billing and extend the availability of network services to the roamer.

WiFi network selection options are described in the document 3GPP 23.234, “3GPP system to wireless Local Area Network (WLAN) interworking”.

In one option, the client is a dialer or like program, and prioritizes the alternatives based on the available networks on the air and the WISPs (Wireless Service Providers) Prioritizing may be based on personal and HPMN criteria such as cost and quality of service (QoS), and is intended to assist the user to connect to the preferred network. The client may therefore communicate with the WLAN card interface, which it may do by replacing such entities as the Windows XP WLAN client for example.

In general, network discovery and selection is composed of two consecutive phases: the selection at the physical/air layer, selecting the hotspot operator, and selection at the service provider level, between the providers that work with the selected hotspot operator. The first selection is done based on the available SSIDs, gathered by the client either by passive or active scanning. The second selection phase is the selection of the actual WISP (Wireless Service Provider)—which may be the same hotspot provider from the level 1 selection, but in general, this is not the case. After selecting the SSID, the user is typically directed to a Web pre-portal, owned by the selected hotspot operator. That pre-portal contains all the WISPs the operator works=with, and there the user is required to manually select one of the WISPs which will actually provide the service, and will actually perform the AAA authentication.

The proposed client preferably performs a seamless automatic network selection, i.e. performs level1 and level2 seamlessly. That requires from the client an analysis of capabilities, with which it can automatically analyze web pre-portal pages (which are usually HTML pages), and automatically select the preferred network for the user. The client has his user's login username and password, and so can perform the login automatically. It is possible for the password to be sent to the user via SMS, as already performed by certain WISPs. In that case, the client may adapt to receive the password from the user. Likewise the client may adapt for cases where the password is not be saved by the client.

After being connected, the client fetches a snapshot from a preferred network database preferably located at the server 134, containing updates of roaming agreements between operators and WiFi providers, and showing which WiFi networks support which kinds of services. The database thus defines alternatives for selecting WiFi partners for each one of the mobile operators. The updates may contain new criteria for selection, new tariffs, new QoS parameters, and any other information which can affect the network selection process.

The client reports its availability to the roaming presence server, and preferably embeds the SIP client within the wireless device.

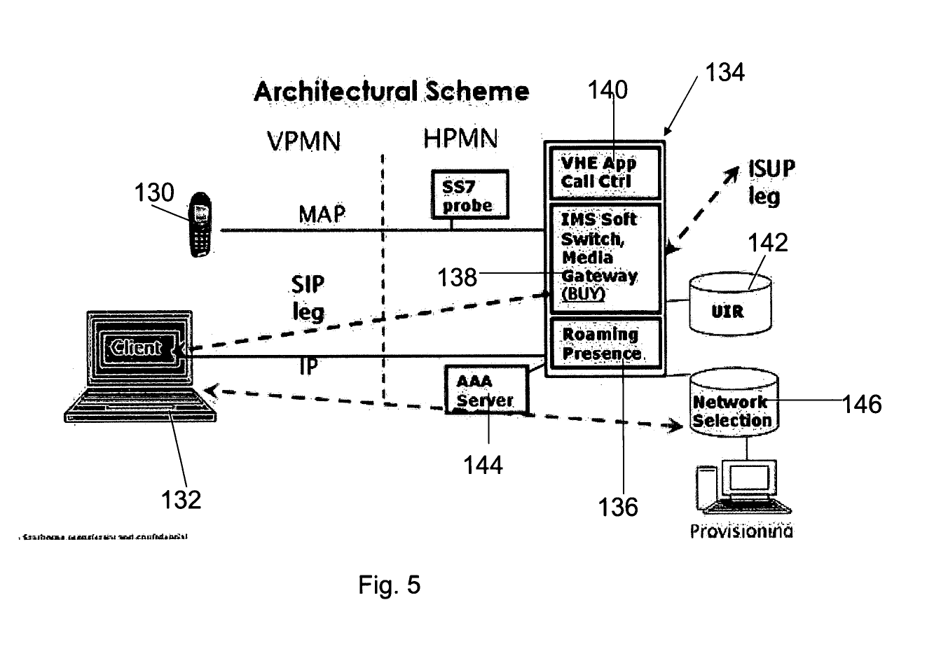

A provisioning system to support the roaming presence system may be provided from an extension of the provisioning system. The provisioning system is shown as part 146 in FIG. 5 below.

The previously described MRPS can be used for presence-based routing. Telephony calls and messages can be routed to the current location and terminal being used by the roamer. The roaming device to which the calls are routed may be a mobile handset or laptop for example, which are currently connected to a WiFi hotspot.

Reference is now made to FIG. 5, which illustrates an architecture for linking between the cellular and IP worlds. Cellular client 130 and IP client 132 belong to the same subscriber. A call is placed to the subscriber and has to be routed to one of his devices. ISUP leg (red arrow at the right side) shows that a call is routed to platform 134, towards the end user. Cellular client 130 is connected to a cellular network through a connection where MAP data is watched by an SS7 probe. The IP client is an SIP client. Server 134 comprises roaming presence functionality 136 which notes which user is connected to which network and allows calls to be forwarded thereto. IMS soft switch media gateway 138, shown here as an option, allows for cellular to be translated into VoIP and vice versa. VHE application call control 140 allows services to be made available across the networks and a network selection database 142 allows for network selection features as will be described below. AAA server 144 carries out authentication on the IP network.

Use of the architecture of FIG. 5 is as described below.

If a mobile terminated (MT) call is received for a given user who happens to be connected through an IP-based wireless LAN using an IP device then the call needs to be converted to voice over IP (VoIP) before sending on to the user. If the subscriber is roaming, that is not on his home cellular network, is connected and registered to a WiFi network via a hotspot and is set to receive calls to his current device, which is a SIP based PC client, then the presence server 10 can be set to route the call to the SIP client as VoIP, using soft switching and media gateway capabilities.

More specifically, forwarding of the MT roaming call is based on a SIP client, installed on the user's laptop prior to use. The user invokes the SIP client after getting connected to a hotspot (the SIP client can be embedded within the Network Selection client), the client reports its presence to the roaming presence server at the HPMN. The user sets its preferences via the client, for example to receive all MT calls, to screen the calls, etc. at a later preference setting phase.

The HPMN system receives a trigger for MT roaming call via INAP. If the call meets the routing criteria, the system requests the MSC to route the call to the system of FIG. 5, which performs soft switch and converts to VoIP. The server establishes a SIP connection to the client, and the client presents the CLI to the user.

The operator may configure the system per visited country/network. The SS7 probe and the UIR, or User Information Repository, an embodiment of the more general multi-dimension presence database described herein, which makes up the roaming presence server, stores the location information for the roamers at the level of the MSC. The UIR record may be extended to include the SIP client identification, as well as other parameters that may be required for billing and other purposes, such as the IP address, the MAC address and other parameters that may be available via say the Radius/Diameter server.

In a further alternative it may be possible to use a SIP application server. Again a specific SIP application could be developed containing logic for specific VHE services.

On the other hand, if the user wishes to send a call from the SIP client then the system allows him to do so and the call looks like a mobile originated (MO) call.

More specifically, the user is able to place MO calls from the SIP client. The call is initially routed in a VoIP leg to the HPMN server, and then converted to ISUP and completed in a final ISUP leg to the final destination.

The roaming presence unit 136 is required for determining the availability of the service per country/network, and the charging of the user-per location. The system creates call data records (CDR) containing all relevant information regarding the VoIP and ISUP legs, so the operator is able to charge the end user for the service.

The same service can be applied for prepaid roaming users, where the platform 134 simply triggers the prepaid system at the user's home network as an integral part of the service.

In either of these cases it is desired to make services such as short code translation, and Global Direct Access (GDA), that is direct access to Voicemail via short code+calling line identification delivery across networks, (CLI delivery), as in the home network, available between the networks. In order to achieve this the SIP client sends the CLI and short dialed number to the server 134 where number translation takes place and the CLI is passed on to the home network service access, if needed, to make the services available.

When a WiFi or other wireless LAN becomes available, the user is directed by a client program to select a wireless LAN that is connected to his network so that he can be billed centrally and have access to his services. The client can then prioritize the available alternatives according to predefined settings or according to user instructions and is then able to make the connection to the network. The activities of the client may be set to be transparent to the user as desired. Network selection can include enabling services only for certain networks.

One of the services that can be made available is to provide a network based user address book. Instead of storing the address book on the cellular telephone or other wireless device separately, a user can store his address book on the network, and any of his devices can access it at any time. The user may even be enabled to view an image of the caller from the address book if such an image has been provided. Note that it is difficult with memory limitations of cellular devices to provide such images when the address book is located on the device.

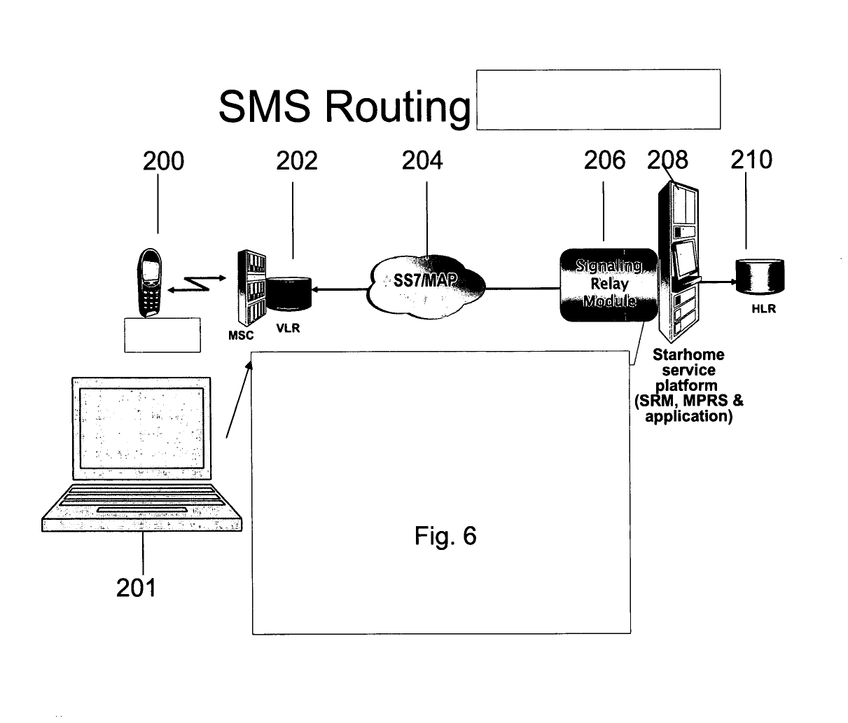

Reference is now made to FIG. 6 which illustrates an example of how context information can be used. Specifically the figure concerns the case of SMS routing to a client running on a laptop, connected via WiFi to the internet.

The user has both handset 200 and laptop 210. The mobile handset is controlled by a visitor location register VLR 202, which in turn is connected (at least in one of the embodiments) via SS7 signaling 204 to signaling relay module 206 and MPRS 208. Note the VLR 202 is in the visited network, while the components 204, 206 and 208 are in the home network (although connected). The SS7 cloud separates between the visited and home network, although it connects to both. MPRS 208 is preferably connected to the user's home location register 210. The connection here is not direct. Platform 208 is connected to the MAP links, which connect the VLR to the HLR.

Platform 208 comprises the presence server or MPRS the SRM and application.

The service application is connected to a Signalling Relay Module (SRM), which controls all MAP links that are connected to the HLR entity of the GSM operator providing the service. The SRM is able to modify all MAP transactions. For this service, the SRM intercepts only SRI_for_SM queries (and associated relevant MAP messages, if any) made towards the HLR. This query is always performed by an SMSC, before issuing the SMS to the user, in order to query the user location (currently serving VLR). The SRM can therefore intercept all these queries, and modify them according to need. The service application has an opportunity to check against the MPRS and determine when an SRI_for_SM is being made for a relevant WiFi user namely a cellular subscriber at the home network, who is currently connected to a WiFi. The application may run the appropriate client software which can receive SMS as a text message via the IP connection. If this is the case, the SRM then blocks the query, that is does not transfer it to the HLR, and instead sends a reply to the source MSC, providing its own address (the service application platform address) as a ‘temporary VLR’ address serving the WiFi user.

The service application platform contains the server software components required for this service, such as the service application itself, the MRPS—if one exists, and other components. The platform acts therefore as a “WiFi” VLR for the relevant WiFi connected subscribers, for the purpose of mobile terminated SMS. The actual SMS reaches the service application platform, and the platform turns the SMS into a text and sends it via IP to the client running on the user's laptop.

Roaming Context Management (RCM) as described herein, provides an infrastructure for Cellular and WLAN interoperability, session handover and service synergism. Interoperability implies roaming between networks, terminals and bearers. The context unit, as described above, holds current session parameters, as well as any current user profile(s) attributes, and ensures that these attributes can be provided to neighboring networks upon handover. The results ensure the transparency of service continuity between different terminals or bearers, for example by minimizing the need for re-authentication. The context shares user attributes of both Cellular and WLAN, enabling the synergy of value added services between these two environments. The MPRS server 10 may be described as context management middleware, with the ability of controlling all session-related parameters with tightly coupled interfaces to the Cellular and WLAN networks.

The MPRS server can receive roaming triggers from both cellular and WLAN networks, using the adaptors shown in FIG. 4, and may therefore act as a unique point of network convergence. Alternatively, different servers can be hosted at different provider networks (Cellular and WLAN), each receiving its own triggers, so that the context is delivered from one RCM to the other as session handover occurs.

A further example of context is as follows. If a phone call begins as a WLAN session, say typically VoIP from a laptop, a context is created at a context unit which may be located at the WLAN provider network. At some point the user may leave the hotspot and would like the call to continue via his mobile telephone. At this point the context may be delivered to another context unit located at the MNO (Mobile Network Operator). The context in effect acts as a personal roaming agent. In effect the context allows a session to become independent of both an individual device and even of a given network. A session can be passed from one device to another or from one network to another.

An optimal solution can be offered to MNOs that are also WLAN providers, in which case a single presence and context server can manage sessions on the mobile network and the wireless LAN. Service synergism, the combination of cellular and WLAN functionality into a one comprehensive service, is particularly relevant for the MNO.

Using the present embodiments, a given user may allow himself to be registered on both cellular and LAN networks. The context is thus a unique point of convergence of networks, enabling services on both cellular and WLAN networks simultaneously, enabling service synergism and session handover between the two networks. But the roaming presence server is also useful for the user who wishes to register only with the cellular network but be able to use any LAN that he passes without having to register separately.

The presence and context server 10 may receive roaming triggers for user presence, from both the cellular and WLAN networks, creating a user context based on a pre-defined user profile if the networks can somehow share one and the same registration details, for example using the embodiments described herein. The term roaming here, as explained above, refers not only to roaming between different mobile networks, but to roaming between network types (GSM, CDMA and WLAN for example) and devices. The source for roaming presence information may thus be registration events, change of presence and change of location.

The system components of server 10, as illustrated in FIGS. 1, 2 and 4, include a context management unit, and adaptors for the different networks: at least a cellular adaptor and a WLAN adaptor.

The system preferably contains a database for user profiles 104, which holds pre-defined profiles for cellular and WLAN users.

Support services that the presence server can provide include the following:

Telephony call handover, as described hereinabove.

IP session continuation, allowing the user to continue browsing from the same web context while moving from cellular to WLAN and vice versa.

Sending a Welcome SMS/MMS/other message types to a hotspot visitor, containing some valuable information regarding the specific hotspot (such as coupons).

SMS interoperability: while logging into a WLAN hotspot, a pop up window may appear on the user's screen. The user will be able to send MO (Mobile Originated) SMS from his window even though he may be using a laptop, and MT (Mobile Terminated) SMS being sent to the user can be routed to the laptop and displayed in this window. For implementation: the presence and context server 10 is aware that the user is logged into the hotspot, and instructs the cellular network to route all MT SMS for that user to the RCM. Then it sends the SMS content to the client application running on the user laptop.

As an alternative, the presence server 10 can monitor SMS notifications going to the specific user, by probing the SS7 MAP links, and send an additional SMS message to the laptop, based on the captured content.

Another service that can be provided is the so-called “Who was calling”. In “who was calling” a pop up window may be displayed to show missed call details. The window may be displayed while logging into a WLAN hotspot. The information can be gathered using a service similar to “Who Called for Roamers” service offered for International roaming, or by any other “missed calls” application The laptop logging into a hotspot can also receive previous SMS messages that were sent to the user mobile before logging into the WLAN hotspot. The messages would typically already be stored at the mobile handset, but may in some cases still be pending at the SMSC, for example if the handset has been turned off in the meantime. In both cases, the user may prefer to read the messages from the laptop screen.

One particular application of the present embodiments is in the case of unlicensed mobile access UMA. UMA is a system for allowing access to the mobile system in ways other than from a cellular base station using the licensed frequency bands. UMA (Unlicensed Mobile Access) is a proposed architecture for WiFi/Mobile interoperability at the “BSC level” (i.e. at the Base Station Controller level). A new component, UNC (UMA Network Controller), supports WiFi connection to the MS on one side and GSM (MSC, SGSN) connectivity on the other, via the A-interface and the Gb respectively. The UNC is actually a relay for GSM/GPRS signaling between the handset and the core network, over an IP transport.

The use of UMA is complementary to the previously described functionality for connecting between wireless LANs and GSM.

UMA uses discovery and registration to register a user using an IP address which is found on his SIM card or configured at the handset level. However, if the user is outside of his usual network then the IP address may not have any meaning and thus the network selection which is an essential part of UMA is not really defined for the roaming situation.

The problem is solved using a presence and context server according to the present embodiments. The presence server detects which network you are currently on and sends you a new IP address which is valid on that location or in that country. The server decides that the user is say in Italy and sends him an updated IP address which will work for UMA in Italy. The IP address is required to work with the core elements of the cellular system so that the home network can give confirmation and allow the core system to acknowledge the handover request. By the term core system is meant the complex comprising the HLR, MSC, and VLR.

Network selection using UMA is as follows: The dual handset has a policy for switching between the GERAN/UMAN modes, and for network selection within each one of the modes. GERAN is GSM-EDGE Radio Access Network; a name for the evolution of GSM towards 3G technology based on EDGE. The term EDGE refers to Enhanced Data rates for GSM Evolution, and indicates a technology that gives GSMA and TDMA similar capacity to handle services for the third generation of mobile telephony. EDGE was developed to enable the transmission of large amounts of data at a high speed, 384 kilobits per second. It achieves this by increasing available time slots and data rates over existing wireless networks. EDGE is also known as Enhanced GPRS (E-GPRS).

The UMA discovery and registration procedure indicates that the “MS (Mobile Handset) supporting UMA may be provisioned (e.g. on the SIM) with the Fully Qualified Domain name (FQDN) or IP address of the Provisioning UNC and the Associated Security Gateway (SGW)”. The roaming scenario requires different IP addresses per country/VPMN addresses. The GSM roaming case can be accommodated by using a service platform to manage the UMA addresses for the roaming subscriber. The discovery and registration process required by UMA may be achieved in one of two ways. In the first way a client is installed at the handset, and connects to a provisioning server which may be the standard UNC provisioning server or a standard roaming extension for this server

In the second way discovery and registration may be carried out using a network-based signaling solution. The solution preferably controls the registration and the authentication procedures.

Another idea, which relates to UMA, is an option to support roaming via the UNC installed at the home network. The UNC at the home network or HPMN may directly control a roaming user, roaming in a VPMN, where the user's client is connected to the UNC directly via IP. There is no need therefore for UNC support at the visited network or VPMN, in order to support the roaming user. The UMA functionality is provided by the home UNC. The home UNC can control a dual-mode cellular handset transparently, without any additional intervention. However, for supporting a VoIP (Voice over IP) client running on a laptop, so that he is be able to place and receive telephony calls, via UNC, additional support is provided in the network. For such clients, there is a need to convert the voice signal from the signaling (SS7) format to a VoIP format (such as SIP), and vice versa. The service application platform described hereinabove has the functionality to convert from SS7 to VoIP, based on presence and availability of the client.

It is expected that during the life of this patent many relevant cellular and wireless telephony devices and systems will be developed and the scope of the terms herein, particularly of the terms “cellular” and “wireless”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A server for tracking presence of wireless devices over a plurality of networks comprising:
a presence & location database, and a plurality of adapters for obtaining wireless device presence or location data from respective ones of said plurality of networks to place in said database, thereby allowing wireless devices to be tracked over said plurality of networks.

2. The server of claim 1, further comprising a network assistance module for selecting a best one of said plurality of networks for a given wireless device to connect to.

3. The server of claim 1, further comprising a processing module for detecting a registration attempt of a wireless device over a first one of said plurality of networks, and forcing said wireless device to reregister at a second one of said plurality of networks.

4. The server of claim 1, being a distributed server.

5. The server of claim 1, configured to have access to user account information associated with said wireless device, thereby to extend to prepaid users access to said plurality of networks.

6. The server of claim 1, wherein one of said networks is a cellular network and a second of said networks is an Internet Protocol (IP) based network.

7. The server of claim 6, configured to extract text message data from the cellular network and relay said data in an IP based format to a wireless device connected via said IP-based network.

8. The server of claim 6, configured to extract voice data from the cellular network and relay said voice data using voice over IP protocol to a voice over IP client located on a wireless device connected via said IP-based network.

9. The server of claim 8, wherein said voice over IP protocol comprises the session initiation protocol (SIP).

10. The server of claim 6, configured to infer location on a first network from location information received at a second network.

11. The server of claim 1, further comprising a processing module for detecting a context associated with a connection over a given one of said plurality of networks.

12. The server of claim 11, wherein said processing module is configured to switch said wireless device to another one of said plurality of networks in accordance with said context.

13. The server of claim 11, wherein said processing module is configured to provide at least one predetermined service to said wireless device, and wherein said processing module is further configured to modify said service according to said context.

14. The server of claim 11, wherein said context can be retained to allow a session to be transferred between one wireless device and another or between one network and another, or between one wireless device on one network and another wireless device on another network.

15. The server of claim 1, further comprising a processing module for extracting data from said database to carry out a handover between a cellular one of said networks and a non-cellular one of said networks.

16. The server of claim 1, further comprising a processing module configured to modify a route of a call or a message to a given subscriber according to said presence or location data in said presence and location database.

17. The apparatus of claim 1, wherein said presence and location server is configured to contain said presence or location data of a subscriber connected via a roaming cellular network or a roaming wireless network.

18. The apparatus of claim 15, wherein said processing module is configured to provide a handover of a wireless device between a non-cellular wireless network and a cellular network.

19. The apparatus of claim 16, wherein said processing module is configured to reroute said call between a non-cellular wireless network and a cellular network.

20. The apparatus of claim 15, wherein said processing module is configured to provide a handover of a connection from said wireless device to a second wireless device connected via a different network.

21. The apparatus of claim 16, wherein said processing module is configured to reroute said call between a wireless device and a second wireless device connected via a different network.

22. The apparatus of claim 20, wherein one of said networks is a wireless non-cellular network and the other of said networks is a cellular network.

23. The apparatus of claim 20 wherein said wirelesses devices are respectively any two of a mobile telephone, a wireless enabled portable computer, and a wireless enabled personal digital assistant.

24. The apparatus of claim 15, wherein said processing module is configured to provide a handover of a connection between said wireless device and another device connected via a different network.

25. The apparatus of claim 16, wherein said processing module is configured to reroute an incoming call between a wireless device and another device connected via a different network.

26. The apparatus of claim 24, wherein said networks are any two of a wireless local area network, a cellular network, a wired network, and the PSTN.

27. The apparatus of claim 24, wherein said devices are any two of a cellular telephone, a computer, a portable computer, a personal digital assistant and a conventional telephone.

28. The apparatus of claim 1, further comprising a user profile database associated with said presence database for making available user customization data to respective wireless devices over said plurality of networks.

29. A method of providing a wireless device with seamless access to a plurality of wireless non-cellular and cellular networks having respective registration systems, the method comprising:
setting one of said networks as a home network for said wireless device;
providing Interworking functionality between said wireless non-cellular and cellular networks to allow a wireless device to connect as a roaming user on a non-cellular or cellular network other than said home network such that said connection is accepted via registration at said home network using a respective home network registration system, thereby allowing said wireless device to move freely between said plurality of non-cellular and cellular networks.

30. The method of claim 29, wherein there is further provided a preferred network database for providing data about connecting via respective networks, said data being usable by a client based on a wireless device to select a preferred network.

31. The method of claim 29, further providing detecting a connection context.

32. The method of claim 31, further comprising using said detected context to modify a wireless service provided to said wireless device.

33. The method of claim 29, comprising providing a handover of a wireless device between a cellular network and a non-cellular network using said interworking functionality.

34. The method of claim 29, further comprising redirecting a call to a given subscriber from a first of said plurality of networks to a second of said plurality of networks.

35. The method of claim 29, comprising providing a handover of a connection from said wireless device to a second wireless device connected via a different network.

36. The method of claim 29, comprising redirecting a call from a first wireless device to a second wireless device belonging to a same subscriber connected via a different network.

37. The method of claim 35, wherein one of said networks is a non-cellular network and the other of said networks is a cellular network.

38. The method of claim 35 wherein said wirelesses devices are respectively any two of a mobile telephone, a wireless enabled portable computer, and a wireless enabled personal digital assistant.

39. The method of claim 29, comprising providing a handover of a connection between said wireless device and another device connected via a different network.

40. The method of claim 39, wherein said networks are any two of a wireless non-cellular network, a cellular network, a wired network, and the PSTN.

41. The method of claim 39 wherein said devices are any two of a cellular telephone, a computer, a portable computer, a personal digital assistant and a conventional telephone.

42. The method of claim 29, comprising adding user profile information to said interworking functionality, thereby to make available customized information to respective wireless devices.

43. A server system for tracking presence and location of wireless devices, the system comprising:
a plurality of servers, each having
a presence database for tracking a plurality of wireless devices over a plurality of networks, and
a plurality of adapters for obtaining wireless device presence data from respective ones of said plurality of networks to place in said database, thereby allowing wireless devices to be tracked over said plurality of networks,
the system being configured such that information is shared between said servers, thereby to permit tracking presence of said wireless devices.

44. A method for determining that a subscriber is in a vehicle, comprising:
receiving location data of a given mobile communication device connected via a wireless network,
if said location data is changing at above a predetermined rate then inferring that the corresponding subscriber is in a moving vehicle.

45. Apparatus for allowing use of unlicensed mobile access to a roaming user connecting at a network other than his home network, the apparatus comprising:
a detector for detecting that said user is roaming at a given roaming location; and
a presence update unit, associated with said detector for sending to said home network and an indication of presence at said roaming location to identify his home network, thereby to allow registration of said roaming user at said home network when connected from said unlicensed mobile access.

46. Apparatus for mediating between a cellular telephony network and a non-cellular wireless network, the apparatus comprising:
a first adaptor for allowing signal exchange with said cellular telephony network;
a second adaptor for allowing signal exchange with said non-cellular wireless network; and
a presence tracker associated with said adaptors for obtaining and storing a current location of a wireless device on any of said networks.

47. The apparatus of claim 46, wherein said second adaptor is configured to provide services of said cellular network to said non-cellular wireless network.

48. The apparatus of claim 47, wherein said services are any one of the group consisting of:
a) intelligent call assistance for assisting with incorrectly dialed numbers;
b) recognition of cellular network defined short dialing codes;
c) direct access to voicemail at said non-cellular network from said cellular network;
d) direct access to services at said non-cellular network that require the transfer of calling line identification (CLI) from the cellular network;
e) delivery of a calling line identification (CLI) to a non-cellular device at a visited network;
f) placing a telephony call from the non-cellular wireless device;
g) sending a text message from the non-cellular wireless device;
h) receiving information on missed calls made to a cellular device at a non-cellular device connected via a non-cellular network; and
i) receiving history information on calls and text messages made to the cellular device at a non-cellular device.

49. The apparatus of claim 48, wherein at least one member of said group is provided via a session initiation protocol (SIP) client.

50. Apparatus for making user profile information available over a plurality of user devices connecting via both IP and cellular networks, the apparatus comprising:
a cellular adaptor for connection to a cellular network;
an IP adaptor for connection to an IP network;
a user profile database for storing user profiles of a plurality of users;
a tracking unit associated with said cellular adaptor, said IP adaptor and said user profile database, for identifying and tracking devices connected to said networks and making user profile data of a corresponding user available for a respective device.

51. Apparatus according to claim 50, wherein the user profile data is address book information.

52. Apparatus according to claim 51, wherein said address book information comprises images relating to subscribers identified therein, the apparatus being configured to send to a respective wireless device an image corresponding to a calling subscriber together with an incoming call.

53. Apparatus according to claim 50, wherein the plurality of devices comprise both cellular devices and IP devices.

54. Apparatus for network selection comprising:
a database storing network parameters for a plurality of available networks, and
a user client, for applying to a wireless-communication-enabled device, for communicating with said database to determine from said network parameters a preferred one of said plurality of network for connection thereto.

55. Apparatus according to claim 54, comprising a network component for providing updated network parameters from said database to said user client.

56. Apparatus for zoned use of a wireless communication device, comprising:
zone determination unit for defining a zone; and
location determination unit for determining a current location of a wireless communication unit, such that at least one predetermined condition is applied if said current location is within said zone.

57. Apparatus according to claim 56 installed as a client within said wireless communication device.

58. Apparatus according to claim 56, wherein said zone is defined in terms of a predetermined number of cells of a wireless communication network.

59. Method for zoned use of a wireless communication device, comprising:
defining a zone; and
determining a current location of a wireless communication unit, such that at least one predetermined condition for communication is applied if said current location is within said zone.
